(19) United States
(12) Patent Application Publication
(10) Pub. No.: US 2007/0245915 A1
(43) Pub. Date: Oct. 25, 2007

(54) Printing plate and method of manufacturing liquid crystal display device using the same

(75) Inventor: Jin Wuk Kim, Gyeonggi-do (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 11/788,992

(22) Filed: Apr. 23, 2007

(30) Foreign Application Priority Data
Apr. 24, 2006 (KR) P2006-036622

(51) Int. Cl. B41N 1/00

(52) U.S. Cl. 101/395

(57) ABSTRACT

A printing plate comprises a plurality of protrusions onto which a pattern material is transcribed, and a plurality of embossing patterns disposed on the protrusions.

This application claims the benefit of Korean Patent Application No. 2006-36622, filed on Apr. 24, 2006, the entirety of which is hereby incorporated by reference.

### FIELD

The present invention relates to a printing plate to form minute patterns of liquid crystal display (LCD) devices and semiconductor devices, and more particularly, to a printing plate to increase a cohesive energy with a pattern material.

### BACKGROUND

Generally, LCD devices and semiconductor devices are provided with a plurality of layers patterned on a substrate. Accordingly, various processes are performed to pattern the plurality of layers. In order to pattern the plurality of layers in various shapes, it is necessary to use photolithography.

The photolithography necessarily uses a mask of a predetermined pattern and a light-irradiation apparatus, so that the manufacturing cost increases. In addition, since the photolithography requires exposure and development, it complicates the process and increases manufacturing time.

To overcome these problems of photolithography, a new patterning method has been developed, for example, a patterning method using a printing roll.

FIGS. 1A to 1C are views illustrating a patterning method using a related art printing roll.

First, as shown in FIG. 1A, a pattern material 20 is applied to a printing roll 30 through a printing nozzle 10, wherein a blanket 35 is adhered to the surface of printing roll 30. That is, the printing roll 30 is coated with the pattern material 20.

After that, as shown in FIG. 1B, the printing roll 30 is rolled on a printing plate 40 provided with a plurality of protrusions 40a. As a result, part of the pattern material 20b are transcribed onto the protrusions 40a of the printing plate 40, and the remaining pattern material 20a forms the predetermined pattern on the printing roll 30.

Referring to FIG. 1C, the printing roll 30 is rotated on a substrate 50, whereby the remaining pattern material 20a of printing roll 30 is transcribed onto the substrate 50, thereby forming the desired pattern on the substrate 50.

If some of the part of the pattern material 20b remains on the printing roll 30 in the process of transcribing the pattern material 20b onto the printing plate 40, the remaining pattern material is transcribed onto the substrate 50, whereby the defective pattern occurs.

Whether the pattern material 20b is completely transcribed onto the printing plate 40 depends on a total cohesive energy between the pattern material 20 and the printing plate 40. If the cohesive energy between the pattern material 20 and the printing plate 40 is large, there is a high possibility that the pattern material 20b is completely transcribed onto the printing plate 40.

The total cohesive energy between the pattern material 20 and the printing plate 40 is determined based on the contact area (S₁) between the pattern material 20 and the printing plate 40 and the cohesive energy per unit area between the pattern material 20 and the printing plate 40.

In the related art, the contact area (S₁) between the pattern material 20 and the printing plate 40 is determined based on the shape of the desired pattern. Whether part of the pattern material 20b is completely transcribed onto the printing plate 40 depends on the cohesive energy per unit area between the pattern material 20 and the printing plate 40, that is, the transcription properties of pattern material 20.

If using the pattern material 20 having poor transcription properties, the defective pattern may occur. Thus, the scope in selecting a material for the pattern material 20 becomes narrow.

### SUMMARY

A printing plate comprises a plurality of protrusions onto which a pattern material is transcribed, and a plurality of embossing patterns disposed on the protrusions.

In another aspect, a method of manufacturing an LCD device comprises forming a light-shielding layer on a first substrate, forming a color filter layer on the first substrate that includes the light-shielding layer, and preparing a second substrate. The method of manufacturing an LCD device further comprises forming a liquid crystal layer between the first substrate and the second substrate. At least any one of forming the light-shielding layer on the first substrate and forming the color filter layer is performed using a printing plate. The printing plate comprises a plurality of protrusions onto which a pattern material is transcribed, and a plurality of embossing patterns disposed on the protrusions.

In yet another aspect, a method of fabricating a layer on a substrate comprises forming the layer on the substrate using a printing plate. The printing plate comprises a plurality of protrusions, onto which a pattern material is transcribed, and a plurality of embossing patterns disposed on the protrusions.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1A to 1C are views illustrating a patterning method using a printing roll according to the related art;

FIG. 2 is a cross section view and an enlarged view illustrating a process of transcribing a pattern material onto protrusions of a printing plate according to one embodiment of the present invention;

FIG. 3 is a perspective view illustrating one among a plurality of embossing patterns formed on a printing plate according to the first embodiment of the present invention;

FIG. 4 is a perspective view illustrating one among a plurality of embossing patterns formed on a printing plate according to the second embodiment of the present invention;

FIG. 5 is a perspective view illustrating one among a plurality of embossing patterns formed on a printing plate according to the third embodiment of the present invention;

FIG. 6 is a perspective view illustrating one among a plurality of embossing patterns formed on a printing plate according to the fourth embodiment of the present invention;

FIGS. 7A to 7D are cross section views illustrating a method of manufacturing an LCD device according to one embodiment of the present invention; and

FIGS. 8A to 8C are cross section views illustrating a method of forming patterns using a printing plate according to another embodiment of the present invention.

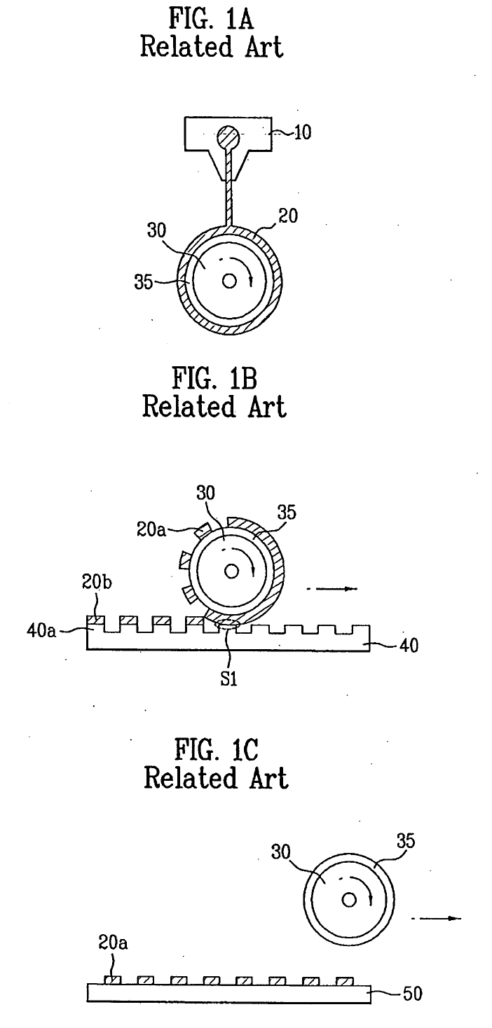

### DETAILED DESCRIPTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a printing plate according to one embodiment of the present invention and a method of manufacturing an LCD device using the same will be explained with reference to the accompanying drawings.

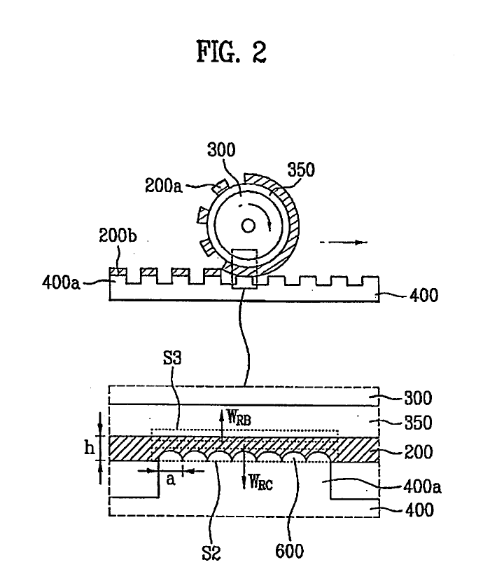

FIG. 2 is a cross section view and an enlarged view illustrating a process of transcribing a pattern material onto protrusions of a printing plate according to one embodiment of the present invention.

Referring to FIG. 2, embossing patterns 600 are formed in the protrusions 400a provided on a printing plate 400. In order to transcribe a pattern material 200 onto the printing plate 400 precisely, there is a requirement that a total cohesive energy between the pattern material 200 and the printing plate 400 is larger than a total cohesive energy between the pattern material 200 and a blanket 350.

The total cohesive energy between the pattern material 200 and the printing plate 400 is measured by multiplying a cohesive energy (W_{RC}) per unit area between the pattern material 200 and the printing plate 400 by a contact area (S₂) between the pattern material 200 and the printing plate 400. The total cohesive energy between the pattern material 200 and the blanket 350 is measured by multiplying a cohesive energy (W_{RB}) per unit area between the pattern material 200 and the blanket 350 by a contact area (S₃) between the pattern material 200 and the blanket 350. This can be expressed as the following equation 1.

S₂W_{RC}>S₃W_{RB} equation 1

In the above equation 1, if the total cohesive energy (S₂W_{RC}) between the pattern material 200 and the printing plate 400 is larger than the total cohesive energy (S₃W_{RB}) between the pattern material 200 and the blanket 350, the pattern material 200 is transcribed onto the printing plate 400 precisely.

As the difference between the total cohesive energy (S₂W_{RC}) generated between the pattern material 200 and the printing plate 400 and the total cohesive energy (S₃W_{RB}) between the pattern material 200 and the blanket 350 increases, the pattern material 200 is more precisely transcribed onto the printing plate 400.

As shown in FIG. 2, if the embossing patterns 600 are formed in the protrusion 400a of the printing plate 400, the contact area (S₂) between the pattern material 200 and the printing plate 400 is larger than the contact area (S₃) between the pattern material 200 and the blanket 350. Thus, the difference between the total cohesive energy (S₂W_{RC}) generated between the pattern material 200 and the printing plate 400 and the total cohesive energy (S₃W_{RB}) between the pattern material 200 and the blanket 350 increases. As a result, the pattern material 200 is more precisely transcribed onto the printing plate 400.

Even though the cohesive energy (W_{RC}) per unit area between the pattern material 200 and the printing plate 400 is small, the pattern material 200 is precisely transcribed onto the printing plate 400 owing to the large contact area (S₂) between the pattern material 200 and the printing plate 400. Accordingly, the scope in selecting a material for the pattern material 200 becomes wider.

At this time, the hemispherical embossing pattern 600 is smaller in volume height than the pattern material transcribed onto the embossing pattern 600. If the volume height of hemispherical embossing pattern 600 is larger than the volume height of pattern material transcribed onto the embossing pattern 600, the embossing pattern 600 may be brought into contact with the blanket 350 through the pattern material 200. As a result, the blanket 350 may be contaminated or spots may occur.

FIG. 3 is a perspective view illustrating one among a plurality of embossing patterns formed on a printing plate according to the first embodiment of the present invention.

As shown in FIG. 3, one of embossing patterns 600 of printing plate 400 is formed within a square, of which one side corresponds to “a”. In order to obtain the volume of hemispherical embossing pattern 600 which is smaller than the volume of pattern material 200 transcribed onto the embossing pattern 600, the diameter (a) of hemispherical embossing pattern 600 satisfies the following equation 2.

$$\frac{1}{2} S \frac{4}{3} {π ( \frac{a}{2} )}^{3} < {a}^{2} h \qquad equation 2$$

In the above equation 2, the left side corresponds to the volume of hemispherical embossing pattern 600 having the diameter “a”. The right side corresponds to the volume of pattern material transcribed on the embossing pattern 600. In this case, “h” corresponds to a thickness of pattern material 200 coated on the printing roll 300, and “a²” corresponds to the area of minimum square among squares inclusive of the circle having the diameter “a”.

By the equation 2, if the diameter “a” of the hemispherical embossing pattern 600 is smaller than 12 h/π, the hemispherical embossing pattern 600 has no effect on the blanket 350.

Except the embossing pattern 600, the printing plate 400 of the second embodiment is identical to that of the first embodiment.

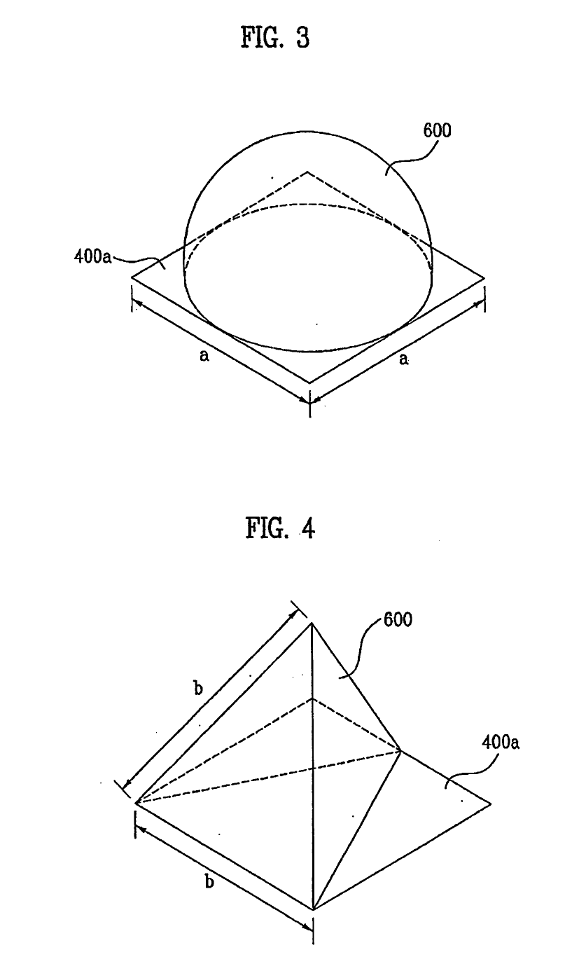

FIG. 4 is a perspective view illustrating one among a plurality of embossing patterns formed on a printing plate according to the second embodiment of the present invention.

Referring to FIG. 4, one of embossing patterns 600 of printing plate 400 is formed of a regular tetrahedron, of which one side corresponds to “b”. In order to obtain the volume of embossing pattern 600 of regular tetrahedron which is smaller than the volume of pattern material 200 transcribed onto the embossing pattern 600, one side (b) of embossing pattern 600 of regular tetrahedron satisfies the following equation 3.

$$\frac{1}{3} ( \frac{\sqrt{3}}{4} {b}^{2} ) \frac{\sqrt{6}}{3} b < \frac{\sqrt{3}}{2} {b}^{2} h \qquad equation 3$$

In the above equation 3, the left side corresponds to the volume of embossing pattern 600 of regular tetrahedron, of which each side is “b”. The right side corresponds to the volume of pattern material transcribed onto the embossing pattern 600. In this case, “h” corresponds to a thickness of pattern material 200 coated on the printing roll 300, and

$$″ \frac{\sqrt{3}}{2} {b}^{2} ″$$

corresponds to the area of minimum square among squares inclusive of the regular triangle having each side “b”.

By the equation 3, if one side “b” of embossing pattern 600 of regular tetrahedron is smaller than 3\sqrt{6h}, the embossing pattern 600 of regular tetrahedron has no effect on the blanket 350.

Except the embossing pattern 600, the printing plate 400 of the third embodiment is identical to that of the first embodiment.

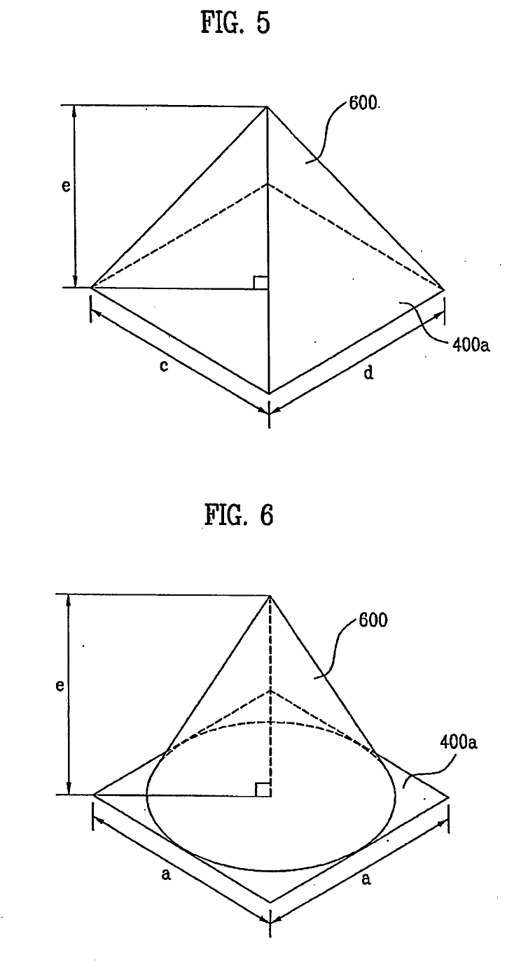

FIG. 5 is a perspective view illustrating one among a plurality of embossing patterns formed on a printing plate according to the third embodiment of the present invention.

Referring to FIG. 5, one of embossing patterns 600 of printing plate 400 is formed of a quadrangular pyramid, which has the height “e” and the bottom having one side “c” and the other side “d”. In order to obtain the volume of embossing pattern 600 of quadrangular pyramid which is smaller than the volume of pattern material 200 transcribed onto the embossing pattern 600, the height (e) of embossing pattern 600 satisfies the following equation 4.

$$\frac{1}{3} cde < cdh \qquad equation 4$$

In the above equation 4, the left side corresponds to the volume of embossing pattern 600 of quadrangular pyramid having the height “e” and the bottom inclusive of one side “c” and the other side “d”. The right side corresponds to the volume of pattern material 200 transcribed onto the embossing pattern 600. In this case, “h” corresponds to a thickness of pattern material 200 coated on the printing roll 300, and “cd” corresponds to the area of bottom of quadrangular pyramid.

By the equation 4, if the height “e” of embossing pattern 600 of quadrangular pyramid is smaller than 3 h, the embossing pattern 600 of quadrangular pyramid has no effect on the blanket 350.

Except the embossing pattern 600, the printing plate 400 of the fourth embodiment is identical to that of the first embodiment.

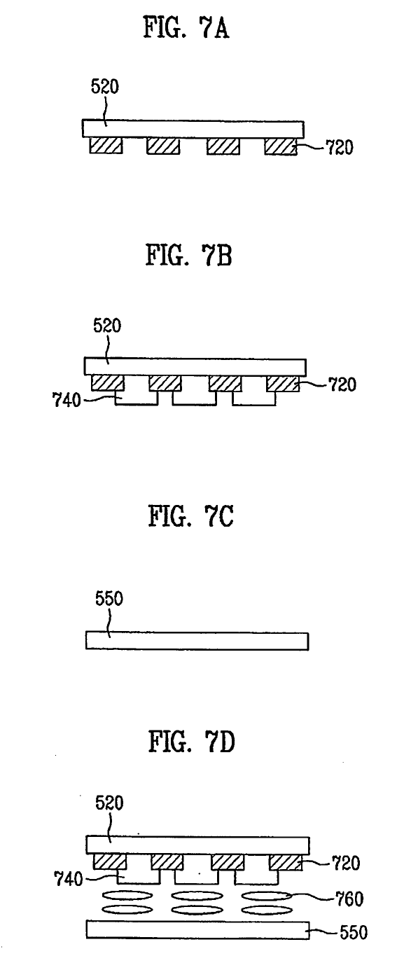

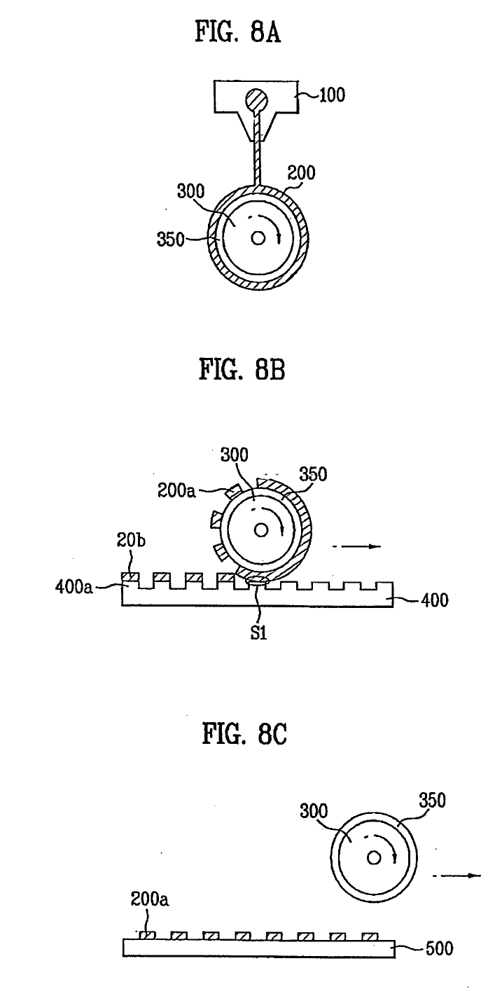

FIG. 6 is a perspective view illustrating one among a plurality of embossing patterns formed on a printing plate according to the fourth embodiment of the present invention.

As shown in FIG. 6, one of embossing patterns 600 is formed of a cone having the height “e” and the circular bottom of which diameter is “a”. In order to obtain the volume of cone-shaped embossing pattern 600 which is smaller than the volume of pattern material 200 transcribed on the embossing pattern 600, the height (e) of cone-shaped embossing pattern 600 satisfies the following equation 5.

$$\frac{1}{3} {π ( \frac{a}{2} )}^{2} e < {a}^{2} h \qquad equation 5$$

In the above equation 5, the left side corresponds to the volume of cone-shaped embossing pattern 600 having the height “e” and the circular bottom of which diameter is “a”. The right side corresponds to the volume of pattern material transcribed onto the embossing pattern 600. In this case, “h” corresponds to a thickness of pattern material 200 coated on the printing roll 300, and “a²” corresponds to the area of minimum square among squares inclusive of the circle having the diameter “a”.

By the equation 5, if the height “e” of cone-shaped embossing pattern 600 is smaller than 12 h/π, the cone-shaped embossing pattern 600 has no effect on the blanket 350.

The shape of embossing pattern 600 is not limited to the above-mentioned preferred embodiments. Within the scope analogized to those skilled in the art, the embossing pattern may vary in shape.

FIGS. 7A to 7D are cross section views illustrating a method of manufacturing an LCD device according to one embodiment of the present invention.

First, as shown in FIG. 7A, a light-shielding layer 720 is formed on a first substrate 520. Then, as shown in FIG. 7B, a color filter layer 740 is formed on the first substrate 520 including the light-shielding layer 720. At this time, at least any one of the step of forming the light-shielding layer 720 (FIG. 7A) and the step of forming the color filter layer 740 (FIG. 7B) is performed by the process of forming the pattern using the above-mentioned printing plate.

The preferable method of forming the pattern using the above-mentioned printing plate will be explained with reference to FIGS. 8A to 8C.

First, as shown in FIG. 8A, the printing roll 300 to which the blanket 350 is adhered is coated with the pattern material 200.

As the printing roll 300 coated with the pattern material 200 is rolled on the printing plate 400, some of pattern material 200b is transcribed onto the printing plate 400, as shown in FIG. 8B.

After that, as shown in FIG. 8C, the printing roll 300 is rolled on the substrate 500, whereby the remaining pattern material 200a of the printing roll 300 is transcribed onto the substrate 500.

The predetermined pattern may be formed on the substrate 500 by the method of FIGS. 8A to 8C.

Then, as shown in FIG. 7C, a second substrate 550 is prepared.

Although not shown, preparing the second substrate 550 is comprised of forming gate and data lines crossing each other to define the pixel region, forming a thin film transistor adjacent to a crossing of the gate and data lines, and forming a pixel electrode electrically connected with the thin film transistor.

As shown in FIG. 7D, a liquid crystal layer 760 is formed between the first substrate 500 and the second substrate 550.

For the present invention, the contact area between the printing plate and the pattern material is increased owing to the embossing patterns formed in the protrusions of printing plate. As the total cohesive energy between the printing plate and the pattern material increases, it is possible to improve the transcription properties of pattern material, thereby realizing the precise pattern.

Also, the contact area increases between the printing plate and the pattern material. Thus, even though the pattern material having poor transcription properties is used, the transcription properties of pattern material are not deteriorated seriously. As a result, the scope in selecting a material for the pattern material becomes wider.

Furthermore, since the volume of embossing pattern formed in the protrusion of printing plate is smaller than the volume of pattern material transcribed on the embossing pattern, the embossing pattern has no effect on the blanket coated on the printing roll.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A printing plate comprising:
a plurality of protrusions, onto which a pattern material is transcribed; and
a plurality of embossing patterns disposed on the protrusions.

2. The printing plate of claim 1, wherein the volume of the embossing pattern is smaller than the volume of the respective pattern material transcribed onto the embossing pattern.

3. The printing plate of claim 1, wherein the embossing patterns are hemispherical.

4. The printing plate of claim 3, wherein the diameter of the hemispherical embossing patterns is smaller than
$$\frac{12}{π} h ,$$
wherein ‘h’ is a thickness of the pattern material to be transcribed onto the embossing pattern.

5. The printing plate of claim 1, wherein the embossing patterns have a regular tetrahedron shape.

6. The printing plate of claim 5, wherein one side of the regular tetrahedron shape is smaller than 3\sqrt{6h}, wherein ‘h’ is a thickness of pattern material to be transcribed onto the embossing pattern.

7. The printing plate of claim 1, wherein the embossing patterns have a quadrangular pyramid shape.

8. The printing plate of claim 7, wherein the height of the quadrangular pyramid shape is smaller than 3 h, wherein ‘h’ is a thickness of pattern material to be transcribed onto the embossing pattern.

9. The printing plate of claim 1, wherein the embossing patterns have a cone shape.

10. The printing plate of claim 9, wherein the height of the cone shape is smaller than
$$\frac{12}{π} h ,$$
wherein ‘h’ is a thickness of pattern material to be transcribed onto the embossing pattern.

11. A method of manufacturing an LCD device, the method comprising:
forming a light-shielding layer on a first substrate;
forming a color filter layer on the first substrate that includes the light-shielding layer;
preparing a second substrate; and
forming a liquid crystal layer between the first substrate and the second substrate,
wherein at least any one of forming the light-shielding layer on the first substrate and forming the color filter layer is performed using a printing plate, the printing plate comprising a plurality of protrusions, onto which a pattern material is transcribed; and a plurality of embossing patterns disposed on the protrusions.

12. The method of claim 11, wherein the volume of the embossing pattern is smaller than the volume of the respective pattern material transcribed onto the embossing pattern.

13. The method of claim 11, wherein the embossing patterns are hemispherical.

14. The method of claim 13, wherein the diameter of the hemispherical embossing patterns is smaller than
$$\frac{12}{π} h ,$$
wherein ‘h’ is a thickness of the pattern material to be transcribed onto the embossing pattern.

15. The method of claim 11, wherein the embossing patterns have a regular tetrahedron shape.

16. The method of claim 15, wherein one side of the regular tetrahedron shape is smaller than 3\sqrt{6h}, wherein ‘h’ is a thickness of pattern material to be transcribed onto the embossing pattern.

17. The method of claim 11, wherein the embossing patterns have a quadrangular pyramid shape.

18. The method of claim 17, wherein the height of the quadrangular pyramid shape is smaller than 3 h, wherein ‘h’ is a thickness of pattern material to be transcribed onto the embossing pattern.

19. The method of claim 11, wherein the embossing patterns have a cone shape.

20. The method of claim 19, wherein the height of the cone shape is smaller than
$$\frac{12}{π} h ,$$
wherein ‘h’ is a thickness of pattern material to be transcribed onto the embossing pattern.

21. The method of claim 11, wherein forming the light-shielding layer or forming the color filter layer using the printing plate comprises:
applying a light-shielding material or a color filter material on a printing roll;
rolling the printing roll coated with the light-shielding material or the color filter material on the printing plate, so as to transcribe part of the light-shielding material or the color filter material onto the printing plate; and
rolling the printing roll on the first substrate, so as to transcribe the remaining light-shielding material or color filter material on the printing roll onto the first substrate.

22. The method of claim 11, wherein preparing the second substrate comprises:
forming gate and data lines that cross each other to define a pixel region;
forming a thin film transistor adjacent to a crossing of the gate and data lines; and
forming a pixel electrode electrically connected to the thin film transistor.

23. A method of fabricating a layer on a substrate, the method comprising:
applying a pattern material on a printing roll;
rolling the printing roll coated with the pattern material on a plurality of protrusions disposed on a printing plate and with a plurality of embossing patterns disposed thereon, so as to transcribe part of the pattern material onto the printing plate; and
rolling the printing roll on the substrate, so as to transcribe the remaining pattern material on the printing roll onto the substrate.

24. The method of claim 23, wherein the volume of the embossing pattern is smaller than the volume of the respective pattern material transcribed onto the embossing pattern.

25. The method of claim 23, wherein the embossing patterns are hemispherical.

26. The method of claim 25, wherein the diameter of the hemispherical embossing patterns is smaller than
$$\frac{12}{π} h ,$$
wherein ‘h’ is a thickness of the pattern material to be transcribed onto the embossing pattern.

27. The method of claim 23, wherein the embossing patterns have a regular tetrahedron shape.

28. The method of claim 27, wherein one side of the regular tetrahedron shape is smaller than 3\sqrt{6h}, wherein ‘h’ is a thickness of pattern material to be transcribed onto the embossing pattern.

29. The method of claim 23, wherein the embossing patterns have a quadrangular pyramid shape.

30. The method of claim 29, wherein the height of the quadrangular pyramid shape is smaller than 3 h, wherein ‘h’ is a thickness of pattern material to be transcribed onto the embossing pattern.

31. The method of claim 23, wherein the embossing patterns have a cone shape.

32. The method of claim 31, wherein the height of the cone shape is smaller than
$$\frac{12}{π} h ,$$
wherein ‘h’ is a thickness of pattern material to be transcribed onto the embossing pattern.
